(19) United States
(12) Patent Application Publication
(10) Pub. No.: US 2022/0414465 A1
(43) Pub. Date: Dec. 29, 2022

(54) INFORMATION LEARNING SYSTEM, INFORMATION LEARNING METHOD, INFORMATION LEARNING PROGRAM, AND INFORMATION LEARNING APPARATUS

(71) Applicant: NEC Corporation, Minato-ku, Tokyo (JP)

(72) Inventors: Takahiro TOIZUMI, Tokyo (JP); Kazutoshi SAGI, Tokyo (JP); Gaku NAKANO, Tokyo (JP); Yasunori BABAZAKI, Tokyo (JP)

(73) Assignee: NEC Corporation, Minato-ku, Tokyo (JP)

(21) Appl. No.: 17/780,751

(22) PCT Filed: Dec. 5, 2019
(86) PCT No.: PCT/JP2019/047660

§ 371 Date: May 27, 2022

(51) Int. Cl. G06N 3/08; G06N 3/04

(52) U.S. Cl. CPC G06N 3/08; G06N 3/0481

(57) ABSTRACT

An information learning system includes: a condition generation unit that generates a condition from training data that are inputted to a neural network; a condition connection unit that connects the condition to a feature quantity of the training data; and an optimization unit that optimizes a parameter of the neural network by using the feature quantity to which the condition is connected. The condition generation unit includes a temperature sampling unit that probabilistically changes a temperature of activation. This makes it possible to appropriately perform the learning of a conditional neural network.

### TECHNICAL FIELD

The present invention relates to an information learning system, an information learning method, an information learning program, and an information learning apparatus that perform learning of a neural network

### BACKGROUND ART

In a neural network, learning may be performed by using training data in which multiple outputs may exist for a single input. For example, there may be learning of a generator that generates various sentences from one meaning, such as the presence or absence of a term of respect, learning of a converter that adjusts a color of clothes of a person from a gray person image and colorizes it, or learning of a decoder that changes a facial expression, or the like. These cannot be represented in a common end-to-end neural network because their inputs and outputs do not correspond in a one-to-one manner.

As a method of avoiding the above-described problems, a conditional learning method, such as a Conditional Variational Auto-Encoder: CVAE (see, for example, Non-Patent Literature 1) or a Conditional Generative Adversarial Nets: CGAN (see, for example, Non-Patent Literature 2), has been proposed. In the CVAE and the CGAN, the learning is performed by additionally inputting a condition information (condition), such as an image label and an attribute, in a middle layer. As described above, it is said that the learned network can express various outputs by using the condition information as an auxiliary input.

### CITATION LIST

### Patent Literature

Patent Literature 1: JP2019-28839A
Patent Literature 2: International Publication WO2017/044064

### Non-Patent Literature

Non-Patent Literature 1: D. P. Kingma et al, ‘Semi-supervised learning with deep generative models’ NIPS2014
Non-Patent Literature 2: M. Mirza et al 2014, ‘Conditional Generative Adversarial Nets’, arXiv:1411. 1784

### SUMMARY

### Technical Problem

The above-described conditional learning method, however, has such a technical problem that it requires design of the training data, such as the number and type of conditions, and its annotation. For example, in Patent Literature 1, a proposed technique/technology is learning a classifier that outputs which class input data belongs to, but the condition information used for learning needs to be known and the annotation is required. In Patent Literature 2, a proposed technique/technology is synthesizing element objects (i.e., condition information) that are synthesizable data, into feature vectors, but the condition information needs to be accumulated in advance in a database, and the annotation is required.

The present invention has been made in view of the above problems, and it is an example object of the present invention to provide an information learning system, an information learning method, an information learning program, and an information learning apparatus that are configured to appropriately perform the learning of a conditional neural network.

### Solution to Problem

An information learning system according to an example aspect of the present invention includes: a condition generation unit that generates a condition from training data that are inputted to a neural network; a condition connection unit that connects the condition to a feature quantity of the training data; and an optimization unit that optimizes a parameter of the neural network by using the feature quantity to which the condition is connected, wherein the condition generation unit includes a temperature sampling unit that probabilistically changes a temperature of activation. An information learning method according to an example aspect of the present invention includes: generating a condition from training data that are inputted to a neural network; connecting the condition to a feature quantity of the training data; optimizing a parameter of the neural network by using the feature quantity to which the condition is connected; and probabilistically changing a temperature of activation when generating the condition.

An information learning program according to an example aspect of the present invention operates a computer: to generate a condition from training data that are inputted to a neural network; to connect the condition to a feature quantity of the training data; to optimize a parameter of the neural network by using the feature quantity to which the condition is connected; and to probabilistically change a temperature of activation when generating the condition.

An information learning apparatus according to an example aspect of the present invention includes: a condition generation unit that generates a condition from training data that are inputted to a neural network; a condition connection unit that connects the condition to a feature quantity of the training data; and an optimization unit that optimizes a parameter of the neural network by using the feature quantity to which the condition is connected, wherein the condition generation unit includes a temperature sampling unit that probabilistically changes a temperature of activation.

### Effect of the Invention

According to the information learning system, the information learning method, the information learning program, and the information learning apparatus in the respective aspects described above, it is possible to appropriately perform the learning of a conditional neural network. More specifically, it is possible to realize the learning of a conditional neural network without preparing the training data including conditions in advance.

### BRIEF DESCRIPTION OF DRAWINGS

FIG. 1 is a block diagram illustrating a hardware configuration of an information learning system according to an example embodiment.

FIG. 2 is a block diagram illustrating a functional configuration for learning of the information learning system according to the example embodiment.

FIG. 3 is a block diagram illustrating a specific configuration of a condition generation unit according to the example embodiment.

FIG. 4 is a flowchart illustrating a flow of a learning operation of the information learning system according to the example embodiment.

FIG. 5 is a block diagram illustrating a functional configuration for estimation of the information learning system according to the example embodiment.

FIG. 6 is version 1 of a block diagram illustrating a configuration of a condition generation unit according to a modified example.

FIG. 7 is version 2 of a block diagram illustrating a configuration of the condition generation unit according to the modified example.

### DESCRIPTION OF EXAMPLE EMBODIMENT

Hereinafter, an information learning system, an information learning method, an information learning program, and an information learning apparatus according to an example embodiment will be described with reference to drawings.

### (Hardware Configuration)

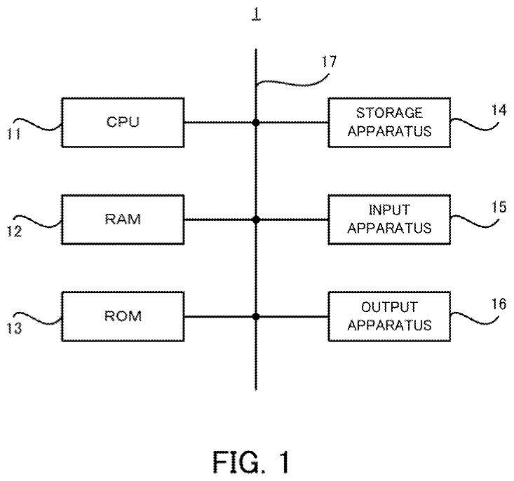

First, a hardware configuration of the information learning system according to the example embodiment will be described with reference to FIG. 1. FIG. 1 is a block diagram illustrating the hardware configuration of the information learning system according to an example embodiment.

As illustrated in FIG. 1, an information learning system 1 according to the example embodiment includes a CPU (Central Processing Unit) 11, a RAM (Random Access Memory) 12, a ROM (Read Only Memory) 13, and a storage apparatus 14. The information learning system 1 may further include an input apparatus 15 and an output apparatus 16. The CPU 11, the RAM 12, the ROM 13, the storage apparatus 14, the input apparatus 15, and the output apparatus 16 are connected through a data bus 17.

The CPU 11 reads a computer program. For example, the CPU 11 is configured to read a computer program stored by at least one of the RAM 12, the ROM 13 and the storage apparatus 14. Alternatively, the CPU 11 may read a computer program stored by a computer readable recording medium using a not-illustrated recording medium read apparatus. The CPU 11 may obtain (i.e., read) a computer program from a not-illustrated apparatus located outside the information learning system 1 through a network interface. The CPU 11 controls the RAM 12, the storage apparatus 14, the input apparatus 15, and the output apparatus 16 by executing the read computer program. Especially in the example embodiment, when the CPU 11 executes the computer program, a functional block for performing the learning of a neural network is implemented in the CPU 11.

The RAM 12 temporarily stores the computer program to be executed by the CPU 11. The RAM 12 temporarily stores the data that is temporarily used by the CPU 11 when the CPU 11 executes the computer program. The RAM 12 may be, for example, a D-RAM (Dynamic RAM).

The ROM 13 stores the computer program to be executed by the CPU 11. The ROM 13 may otherwise store fixed data. The ROM 13 may be, for example, a P-ROM (Programmable ROM).

The storage apparatus 14 stores the data that is stored for a long term by the information learning system 1. The storage apparatus 14 may operate as a temporary storage apparatus of the CPU 11. The storage apparatus 14 may include, for example, at least one of a hard disk apparatus, a magneto-optical disk apparatus, an SSD (Solid State Drive), and a disk array apparatus.

The input apparatus 15 is an apparatus that receives an input instruction from a user of the information learning system 1. The input apparatus s 15 may include, for example, at least one of a keyboard, a mouse, and a touch panel.

The output apparatus 16 is an apparatus that outputs information about the information learning system 1 to the outside. For example, the output apparatus 16 may be a display apparatus (e.g., a display) that is configured to display the information about the information learning system 1.

### (Functional Configuration for Learning)

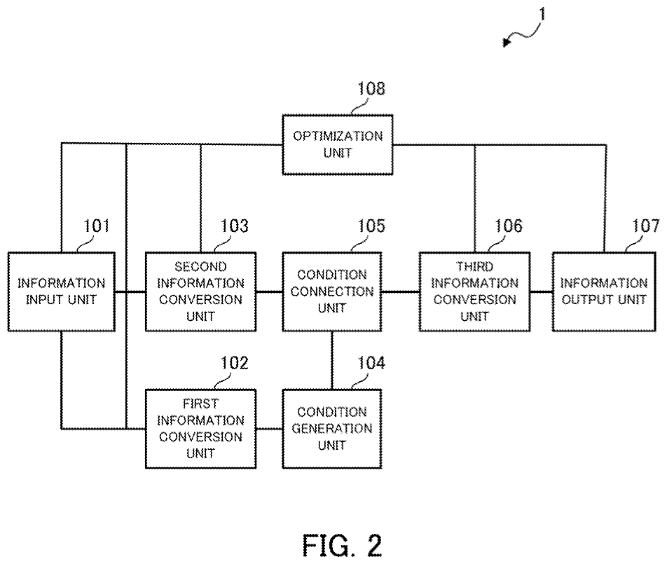

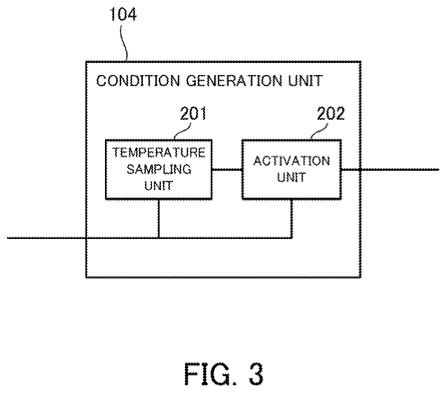

Next, a functional configuration for learning of the information learning system 1 according to the example embodiment will be described with reference to FIG. 2 and FIG. 3. FIG. 2 is a block diagram illustrating the functional configuration for learning of the information learning system according to the example embodiment. FIG. 3 is a block diagram illustrating a specific configuration of a condition generation unit according to the example embodiment.

As illustrated in FIG. 2, the information learning system 1 according to the example embodiment is configured as a system for allowing a neural network to learn by using training data. The information learning system 1 includes, as functional blocks for realizing its function, an information input unit 101, a first information conversion unit 102, a second information conversion unit 103, a condition generation unit 104, a condition connection unit 105, a third information conversion unit 106, an information output unit 107, and an optimization unit 108.

The information input unit 101 inputs information such as a vector, from the outside. The information inputted to the information input unit 101 is a vector or a tensor, such as image data, video data, audio data, and table data, a middle layer vector of a neural network, or the like, and is not particularly limited as long as it can be quantified. The information inputted to the information input unit 101 is training data obtained by a combination of an input information and a target information used in the learning of a neural network.

The first information conversion unit 102 converts the target information in the training data inputted to the information input unit 101, into a feature vector. Specifically, the first information conversion unit 102 extracts the feature vector from the inputted data by using a feature extractor, such as a ResNet (Residual Network) or a VGG. As an extracted feature quantity, basically, a vector with a dimension corresponding to the number of conditions is assumed. For example, a linear layer that is a final layer of the feature extractor may be replaced with a linear layer having a modified number of labels. As the feature extractor used in the first information conversion unit 102, a network that is pre-trained by an ImageNet or the like may be used. The information outputted from the first information conversion unit 102 is not limited to a vector, but may be, for example, a third order tensor such as an image. More specifically, the information outputted from the first information conversion unit 102 may have any shape that allows the information to be coupled with information obtained from the second information conversion unit 103 in the condition connection unit 105 described later.

The second information conversion unit 103 converts the input information in the training data inputted to the information input unit 101, into a feature vector. That is, the second information conversion unit 103 is an encoder unit of an autoencoder that uses a neural network. For example, when the information inputted is an image, the second information conversion unit 103 is a convolutional neural network. In this case, the feature vector outputted from the second information conversion unit 103 is a vector having a channel and a vertical and horizontal size. Alternatively, when the information inputted is a sentence, the second information conversion unit 103 may be configured as an encoder unit of a Long Shot Term Memory (LSTM) and a Transformer or the like. When the second information conversion unit 103 is a LSTM, it outputs a semantic vector, and when it is a Transformer, it outputs an attention vector of each word of a sentence.

The condition generation unit 104 converts the feature vector of the target information extracted by the first information conversion unit 102, into a condition vector (specifically, a one-hot vector). The condition generation unit 104 outputs the condition vector by inputting the feature vector to a softmax function.

Here, in particular, when the softmax function is directly used in the learning, an output value is close to “0” for elements other than an element in which the output value approaches “1”, and this makes it hard to generate a gradient caused by error back propagation. This results in such a problem that the learning of the first information conversion unit 102 for condition generation (i.e., condition vector conversion) does not proceed. In order to avoid this problem, the following equation (1) is defined, wherein a temperature T is introduced into the softmax function as an activation function used by an activation unit 202 of the condition generation unit 104 (see FIG. 3).

$${q}_{i} = \frac{exp ( {z}_{i} / T )}{{\sum }_{j} exp ( {z}_{j} / T )} \qquad [ Equation 1 ]$$

The softmax function with the temperature T introduced outputs a vector having an enhanced/emphasized condition vector when the temperature T has a relatively small value, whereas the softmax function outputs a vector having each element with averaging performed when the temperature T has a relatively large value. In particular, when the temperature T is relatively large as in the latter case, each element does not approach “0”, and thus, the neural network easily generates the gradient caused by error back propagation. It is therefore possible to recommend the learning of the first information conversion unit 102 for condition generation.

In the above-described example, however; the learning of the first information conversion unit 102 can be advanced, whereas averaging is performed in each element. Hence, there arises a problem in which the learning related to the generation of the condition vector cannot be performed in the condition generation unit 104. In order to solve such a trade-off problem between the learning of the first information conversion unit 102 and the learning of the condition generation unit 104, the condition generation unit 104 uses a temperature sampling unit 201 (see FIG. 3) and samples the temperature T by a uniform random number in the learning. Specifically, the temperature sampling unit 201 uses a minimum value Tmin and a maximum value Tmax of the temperature T, and performs the sampling by the uniform random number as in the following equation (2).

[Equation 2]

T˜U(Tₘᵢₙ,Tₘₐₓ) (2)

In this way, when the sampled temperature T is relatively large, averaging is performed in each element and the learning of the first information conversion unit 102 is performed. On the other hand, when the sampled temperature T is relatively small, the condition vector is enhanced/emphasized and the learning of the condition generation unit 104 is performed. It is therefore possible to advance the learning while avoiding the trade-off between the first information conversion unit 102 and the condition generation unit 104.

A distribution function of the temperature sampled by the temperature sampling unit 201 is not limited to the above-described uniform distribution. Other distribution functions include, for example, a Gaussian distribution, an exponential distribution, a Bernoulli distribution, and the like.

The condition connection unit 105 connects the feature vector outputted from the second information conversion unit 103 and the condition vector outputted from the condition generation unit 104 in a channel direction. The condition connection unit 105 and the condition generation unit 104 described above can be expressed as a module of an internal structure of the neural network. The number of modules within the neural network may not limited to be single but may be plural.

The third information conversion unit 106 uses the two vectors connected by the condition connection unit 105 as inputs, and outputs decoded information. That is, the third information conversion unit 106 is a decoder unit of the autoencoder of the neural network.

Incidentally, the autoencoder configured in the second information conversion unit 103 and the third information conversion unit 106 may have a structure like a U-net. In this case, a middle layer of the smallest size is the condition connection unit 105, but each shortcut part other than the middle layer of the smallest size may allow condition connection. Furthermore, when the autoencoder configured in the second information conversion unit 103 and the third information conversion unit 106 is a Transformer, the second information conversion unit 103 is an encoder and the third information conversion unit 106 is a decoder. In this case, the attention vector obtained from the second information conversion unit 103 that is an encoder is an input in each layer of the third information conversion unit 106 that is a decoder. Even in this case, as in the case of the U-net, in place of performing the condition connection only in a part, it is possible to perform the condition connection in all the attention vectors that are inputted to the third information conversion unit 106 that is a decoder.

The information output unit 107 is configured to output the information converted by the third information conversion unit 106 to the outside. Here, information outputted is, for example, an image, a sentence, or the like, and the information output unit 107 is allowed to output various information as in the information inputted to the information input unit 101.

The optimization unit 108 compares the target information in the training data inputted to the information input unit 101 with the information outputted from the information output unit 107 and generates an error function. As the error function here, for example, a mean square error or the like may be used. The optimization unit 108 uses the generated error function and calculates a gradient for each parameter of the neural network by the error back propagation. Then, the optimization unit 108 uses the calculated gradient and optimizes parameters of the neural network. As an optimization method, for example, an SGD (Stochastic Gradient Descent) or Adam or the like may be used. A configuration of the optimization unit 108 described above is merely an example, and there is no particular limitation on the error function and the optimization method to be used.

### (Flow of Learning Operation)

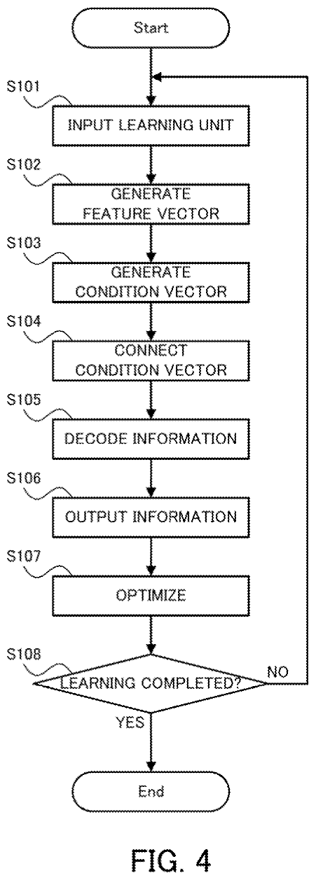

Next, a flow of a learning operation of the information learning system 1 according to the example embodiment will be described with reference to FIG. 4. FIG. 4 is a flowchart illustrating the flow of the learning operation of the information learning system according to the example embodiment.

As illustrated in FIG. 4, in the learning operation of the information learning system 1 according to the example embodiment, the training data are firstly inputted to the information input unit 101 (step S101). Then, the first information conversion unit 102 and the second information conversion unit 103 convert each of the input information and the target information in the inputted training data, into a feature vector (step S102).

Subsequently, the condition vector generation unit 104 converts the feature vector converted by the first information conversion unit 102 (i.e., the feature vector of the target information) into a condition vector (step S103). The condition connection unit 105 connects the condition vector converted by the condition vector generation unit 104 to the feature vector converted by the second information conversion unit 103 (i.e., the feature vector of the input information) (step S104).

Subsequently, the third information conversion unit 106 decodes and outputs the two vectors connected by the condition connection unit 105 (step S105). The information output unit 107 outputs the information obtained by the third information conversion unit 106 (step S106).

By using the information obtained by a series of operation steps described above, the optimization unit 108 optimizes the parameters of the neural network (step S107). Then, when it is determined that learning of the neural network is completed (step S108: YES), the learning operation is ended. The end of the learning operation can be determined, for example, by whether or not there are the training data that are not used for learning. When it is determined that the learning is not completed (the step S108: NO), the step S101 is started again by using other training data.

### (Functional Configuration for Estimation)

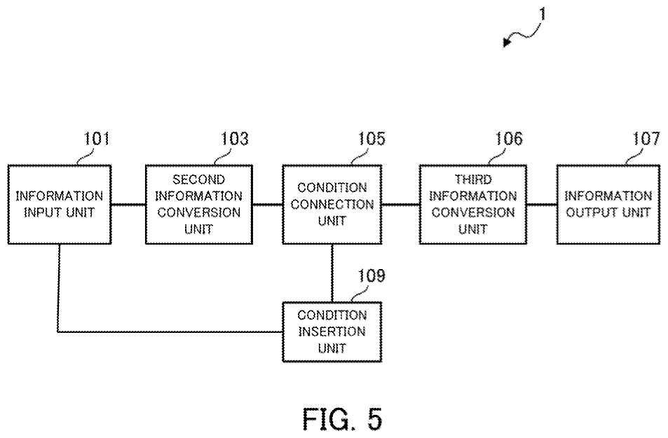

Next, a functional configuration for estimation of the information learning system 1 according to the example embodiment will be described with reference to FIG. 5. FIG. 5 is a block diagram illustrating a functional configuration for estimation of the information learning system according to the example embodiment.

As illustrated in FIG. 5, the information learning system 1 according to the example embodiment is also allowed to operate as a system for estimating information by using a learned neural network. The information learning system 1 includes, as functional blocks for realizing its function, a condition insertion unit 109 in addition to the information input unit 101, the second information conversion unit 103, the condition connection unit 105, the third information conversion unit 106, and the information output unit 107.

The condition insertion unit 109 inserts a condition vector inputted to the information input unit 101 (i.e., a one-hot vector) to the condition connection unit 105.

Thus, it is possible to control the information outputted from the information output unit 107 in the same manner as when the learning is performed with the conditional training data.

### Modified Example

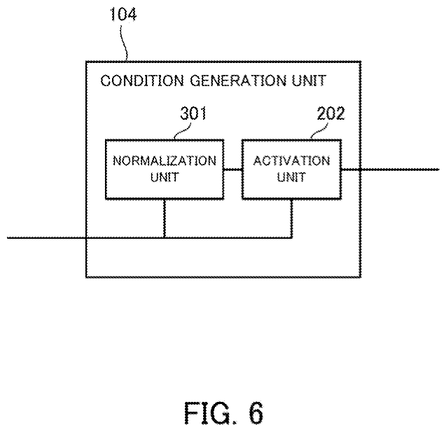

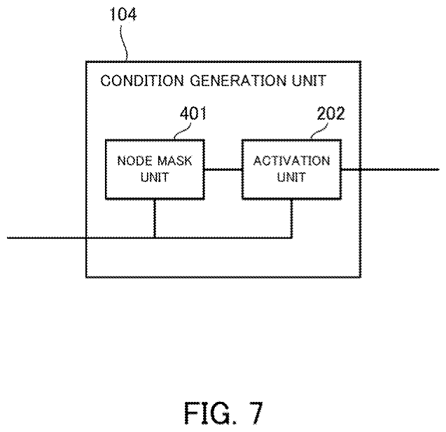

Next, a modified example of the information learning system 1 (especially, the condition generation unit 104) according to the example embodiment will be described with reference to FIG. 6 and FIG. 7. FIG. 6 is version 1 of a block diagram illustrating a configuration of the condition generation unit according to the modified example. FIG. 7 is version 2 of a block diagram illustrating the configuration of the condition generation unit according to the modified example.

As illustrated in FIG. 6, the condition generation unit 104 may include a normalization unit 301 in place of the temperature sampling unit 201 (see FIG. 3). In this case, the normalization unit 301, for example, performs batch normalization and then inputs the feature vector to the activation unit 202 (i.e., softmax function). This makes it possible to suppress a dispersion of the feature vectors before inputting them to the softmax function, and to avoid gradient disappearance. It is therefore possible to solve the already described trade-off problem in the learning. Incidentally, the normalization unit 301 is not limited to the batch normalization, and may use other normalization techniques.

As illustrated in FIG. 7, the condition generation unit 104 may include a node mask unit 401 in place of the temperature sampling unit 201 (see FIG. 3). The node mask unit 401, for example, performs a dropout and then inputs the feature vector to the activation unit 202 (i.e., softmax function). This makes it possible to suppress the dispersion of the feature vectors before inputting them to the softmax function, and to avoid the gradient disappearance. It is therefore possible to solve the already described trade-off problem in the learning. Incidentally, the node mask unit 401 is not limited to the dropout, and may use other node mask methods.

The condition generation unit 104 may not only use each of the temperature sampling unit 201, the normalization unit 301, and the node mask unit 401, independently, but also may use a combination of them.

### Technical Effect

Next, a technical effect obtained by the information learning system 1 according to the example embodiment will be described.

As described in FIG. 1 to FIG. 7, according to the information learning system 1 in the example embodiment, the condition vector is generated from the training data, and the condition vector is connected to the feature quantity of the training data. Therefore, even if the training data including conditions are not prepared in advance, it is possible to allow a conditional neural network to appropriately learn.

Especially in the example embodiment, the condition generation unit 104 is configured to include at least one of the temperature sampling unit 201, the normalization unit 301, and the node mask unit 401. This makes it possible to suppress the dispersion of the feature vectors before inputting them to the softmax function, and to avoid the gradient disappearance. It is therefore possible to appropriately perform the learning of the first information conversion unit 102 and the learning of the condition generation unit 104.

### <Supplementary Notes>

The following Supplementary Notes will be further disclosed for the example embodiment described above.

### (Supplementary Note 1)

An information learning system described in Supplementary Note 1 is an information learning system including: a condition generation unit that generates a condition from training data that are inputted to a neural network; a condition connection unit that connects the condition to a feature quantity of the training data; and an optimization unit that optimizes a parameter of the neural network by using the feature quantity to which the condition is connected, wherein the condition generation unit includes a temperature sampling unit that probabilistically changes a temperature of activation.

### (Supplementary Note 2)

An information learning system described in Supplementary Note 2 is the information learning system described in Supplementary Note 1, wherein the neural network has a softmax output in a middle layer.

### (Supplementary Note 3)

An information learning system described in Supplementary Note 3 is the information learning system described in Supplementary Note 1 or 2, wherein the information learning system further comprises a first feature generation unit that generates a first feature vector from a target information in the training data, and the condition generation unit generates a condition vector as the condition from the first feature vector.

### (Supplementary Note 4)

An information learning system described in Supplementary Note 4 is the information learning system described in Supplementary Note 3, wherein the information learning system further comprises a second feature generation unit that generates a second feature vector as the feature quantity from an input information in the training data, and the condition connection unit connects the condition vector to the second feature vector.

### (Supplementary Note 5)

An information learning system described in Supplementary Note 5 is the information learning system described in any one of Supplementary Notes 1 to 4, further including a normalization unit that normalizes the feature quantity of the training data before the activation, in place of the temperature sampling unit.

### (Supplementary Note 6)

An information learning system described in Supplementary Note 6 is the information learning system described in any one of Supplementary Notes 1 to 4, further comprising a node mask unit that masks a node immediately before the activation, in place of the temperature sampling unit.

### (Supplementary Note 7)

An information learning system described in Supplementary Note 7 is the information learning system described in any one of Supplementary Notes 1 to 6, wherein the neural network includes an information conversion unit including an encoder and a decoder.

### (Supplementary Note 8)

An information learning method described in Supplementary Note 8 is an information learning method including: generating a condition from training data that are inputted to a neural network; connecting the condition to a feature quantity of the training data; optimizing a parameter of the neural network by using the feature quantity to which the condition is connected; and probabilistically changing a temperature of activation when generating the condition.

### (Supplementary Note 9)

An information learning program described in Supplementary Note 9 is an information learning program that operates a computer: to generate a condition from training data that are inputted to a neural network; to connect the condition to a feature quantity of the training data; to optimize a parameter of the neural network by using the feature quantity to which the condition is connected; and to probabilistically change a temperature of activation when generating the condition.

### (Supplementary Note 10)

An information learning apparatus described in Supplementary Note 10 is an information learning apparatus including: a condition generation unit that generates a condition from training data that are inputted to a neural network; a condition connection unit that connects the condition to a feature quantity of the training data; and an optimization unit that optimizes a parameter of the neural network by using the feature quantity to which the condition is connected, wherein the condition generation unit includes a temperature sampling unit that probabilistically changes a temperature of activation.

The present invention is not limited to the examples described above and is allowed to be changed, if desired, without departing from the essence or spirit of the invention which can be read from the claims and the entire specification. An information learning system, an information learning method, an information learning program, and information learning apparatus with such changes are also intended to be within the technical scope of the present invention.

### DESCRIPTION OF REFERENCE CODES

1 Information learning system
11 CPU
12 RAM
13 ROM
14 Storage apparatus
15 Input apparatus
16 Output apparatus
17 Data bus
101 Information input unit
102 First information conversion unit
103 Second information conversion unit
104 Condition generation unit
105 Condition connection unit
106 Third information conversion unit
107 Information output unit
108 Optimization unit
109 Condition insertion unit
201 Temperature sampling unit
202 Activation unit
301 Normalization unit
401 Node mask unit

What is claimed is:

1. An information learning system comprising:
at least one memory that is configured to store informations; and
at least one processor that is configured to execute instructions
to generate a condition from training data that are inputted to a neural network;
to connect the condition to a feature quantity of the training data;
to optimize a parameter of the neural network by using the feature quantity to which the condition is connected,
to probabilistically change a temperature of activation when generating the condition.

2. The information learning system according to claim 1, wherein the neural network has a softmax output in a middle layer.

3. The information learning system according to claim 1, wherein
the information learning system further comprises a processor that is configured to execute instructions to generate a first feature vector from a target information in the training data, and
the processor generates a condition vector as the condition from the first feature vector.

4. The information learning system according to claim 3, wherein
the information learning system further comprises a processor that is configured to execute instructions to generate a second feature vector as the feature quantity from an input information in the training data, and
the processor connects the condition vector to the second feature vector.

5. The information learning system according to claim 1, further comprising a processor that is configured to execute instructions to normalize the feature quantity of the training data before the activation, in place of probabilistically changing the temperature of activation.

6. The information learning system according to claim 1, further comprising a processor that is configured to execute instructions to mask a node immediately before the activation, in place of probabilistically changing the temperature of activation.

7. The information learning system according to claim 1, wherein the neural network includes an encoder and a decoder.

8. An information learning method comprising:
generating a condition from training data that are inputted to a neural network;
connecting the condition to a feature quantity of the training data;
optimizing a parameter of the neural network by using the feature quantity to which the condition is connected; and
probabilistically changing a temperature of activation when generating the condition.

9. A non-transitory recording medium on which an information learning program that allows a computer to execute an information learning method is recorded, the information learning method comprising:
generating a condition from training data that are inputted to a neural network;
connecting the condition to a feature quantity of the training data;
optimizing a parameter of the neural network by using the feature quantity to which the condition is connected; and
probabilistically changing a temperature of activation when generating the condition.

10. (canceled)
